(19) United States
(12) Patent Application Publication
(10) Pub. No.: US 2026/0106345 A1
(43) Pub. Date: Apr. 16, 2026

(54) REFERENCE ELECTRODE, LONG-LIFESPAN THREE-ELECTRODE BATTERY AND PREPARATION METHOD THEREOF, AND METHOD FOR RECOVERING CAPACITY OF BATTERY

(71) Applicant: Tongji University, Yangpu District (CN)

(72) Inventors: Jiangong ZHU, Jiading District (CN); Halfeng DAI, Jiading District (CN); Xiuwu WANG, Jiading District (CN); Haonan LIU, Jiading District (CN); Xuezhe WEI, Jiading District (CN)

(73) Assignee: Tongji University, Yangpu District (CN)

(21) Appl. No.: 18/961,856

(22) Filed: Nov. 27, 2024

(30) Foreign Application Priority Data
Oct. 15, 2024 (CN) 202411440653.1

(51) Int. Cl. H01M 50/569; H01M 4/02; H01M 4/134; H01M 10/0525; H01M 10/0585; H01M 10/0587; H01M 10/42; H01M 10/44; H01M 50/534

(52) U.S. Cl. CPC H01M 50/569; H01M 4/134; H01M 10/0525; H01M 10/0585; H01M 10/0587; H01M 10/4235; H01M 10/44; H01M 50/534; H01M 2004/021

(57) ABSTRACT

Provided are a reference electrode, a long-lifespan three-electrode battery and a preparation method thereof and a method for recovering capacity of a battery. The reference electrode includes a current collector, an active layer, and an anti-oxidation layer, the active layer and the anti-oxidation layer being sequentially coated on a surface of the current collector, wherein a material of the active layer includes one selected from the group consisting of a lithium-ion battery active material and a sodium-ion battery active material; and a content of the material of the active layer in the reference electrode is in a range of 0.05-0.08 g/cm²; and a material of the anti-oxidation layer comprises a solid-state electrolyte.

### CROSS-REFERENCE TO RELATED APPLICATION

This patent application claims the benefit and priority of Chinese Patent Application No. 2024114406531 filed with the China National Intellectual Property Administration on Oct. 15, 2024, the disclosure of which is incorporated by reference herein in its entirety as part of the present application.

### TECHNICAL FIELD

The present disclosure relates to the technical field of rechargeable batteries, and particularly to a reference electrode, a method for preparing a long-lifespan three-electrode battery and a method for recovering capacity of a battery.

### BACKGROUND

Developing clean energy, especially rechargeable secondary batteries, is currently the main research content of the new energy industry. Lithium-ion batteries, with the advantages of high energy density, high coulombic efficiency, long cycle life, etc., have been widely used in the fields of energy storage, electric vehicles, consumer electronics, and transportation. Due to increasing battery capacity and expanded application scenarios at present, traditional battery management systems fail to meet the requirements for efficient information acquisition and management at a cell level, and also have deficiencies in improving battery safety and reliability.

In the prior art, the three-electrode design of most batteries involves implantation between the positive and negative electrodes of the batteries, including the following two types: implantation during initial manufacturing of batteries and modification of batteries in service; moreover, the research on the above batteries mainly focuses on the monitoring of positive electrode potential and negative electrode potential of the batteries and the impedance analysis of the batteries. Firstly, for the implantation of a reference electrode during the initial manufacturing of a battery, an electrochemically stable material can be selected as an active material of the reference electrode, such as lithium titanium oxide (Li₄Ti₅O₁₂, LTO) and lithium iron phosphate (LiFePO₄, LFP). The above materials are usually coated onto a copper wire or a porous metal mesh, and after the formation of a battery, the positive and negative electrodes thereof respectively form a current circuit with the reference electrode for activation. The above process is cumbersome and is not conducive to large-scale production. Secondly, for modification of a battery in service, it is usually required to prevent the electrode sheets and electrolyte solution of the battery from air oxidation in a glove box; moreover, the modification process encounters the problems of damage to the electrode sheets of the battery, uneven electrode sheets caused by the utilization of additional material such as a separator for the implantation of a reference electrode, incapability of realizing large-scale production, etc. Finally, the above solutions both focus on the monitoring of the internal positive electrode potential and negative electrode potential of a battery improved by a reference electrode and the estimation of parameters such as SOC and SOH of the battery obtained in subsequent data processing; moreover, the reference electrode has a low active material load and is difficult to run stably for a long time. More importantly, none of the current technical solutions achieves, during battery preparation, the preparation of a reference electrode that has stable properties in air and is capable of monitoring the internal positive electrode potential and negative electrode potential of a battery and achieving the function of recovering the capacity of an aged battery during cycling.

### SUMMARY

The object of the present disclosure is to provide a reference electrode, a method for preparing a long-lifespan three-electrode battery, and a method for recovering a capacity of a battery, to overcome the problems of reference electrodes in existing technical solutions having a low active material load and instable potential and being difficult to be implanted, likely to cause damage to battery performance, incapable of improving the cycle performance of batteries and achieving battery capacity recovery, etc.

In order to achieve the above object, the present disclosure proposes the following technical solutions:
The present disclosure provides a reference electrode, including a current collector, an active layer, and an anti-oxidation layer, the active layer and the anti-oxidation layer being sequentially coated on a surface of the current collector, wherein
a material of the active layer comprises one selected from the group consisting of a lithium-ion battery active material and a sodium-ion battery active material, and a content of the material of the active layer in the reference electrode is in a range of 0.05-0.08 g/cm²; and
a material of the anti-oxidation layer comprises a solid-state electrolyte.

In some embodiments, the active layer has a thickness of not less than 6 μm; and the anti-oxidation layer has a thickness of 2-3 μm.

In some embodiments, one end of the reference electrode further comprises a reference electrode tab, the reference electrode tab being a nickel tab surface-plated with copper.

The present disclosure further provides a long-lifespan three-electrode battery, including a cell body, an electrolyte solution, and a battery case,
wherein the cell body comprises a positive electrode, a negative electrode, a separator, and a reference electrode, the reference electrode being the reference electrode as described in the above technical solution.

In some embodiments, the cell body includes one selected from the group consisting of a laminated cell body and a wound cell body, wherein
the laminated cell body includes the positive electrode, the reference electrode and the negative electrode that are sequentially stacked, the separator being disposed between the reference electrode and the positive electrode and between the reference electrode and the negative electrode; and
the wound cell body includes the positive electrode, the reference electrode, and the negative electrode that are sequentially stacked and wound, the separator being disposed between the reference electrode and the positive electrode and between the reference electrode and the negative electrode.

In some embodiments, one end of the positive electrode further includes a positive electrode tab, the positive electrode tab being an aluminum tab;
one end of the negative electrode further includes a negative electrode tab, the negative electrode tab being a nickel tab;
the positive electrode tab and the negative electrode tab are located on a same side of the cell body; and
the reference electrode tab is located on a same side or an opposite side of the positive electrode tab.

In some embodiments, the long-lifespan three-electrode battery includes one selected from the group consisting of a pouch battery and a prismatic battery, and the battery case of the pouch battery is an aluminum plastic film case.

The present disclosure further provides a method for preparing the long-lifespan three-electrode battery of the above technical solution, including:
providing the cell body; and
placing the cell body in the battery case, filling the battery case with the electrolyte solution and sealing the battery case, and subjecting a resulting battery system to formation and sorting in sequence, to obtain the long-lifespan three-electrode battery.

The present disclosure also provides a method for recovering capacity of a battery, the battery being the long-lifespan three-electrode battery as described in the above technical solution or a long-lifespan three-electrode battery prepared by the method as described in the above technical solution, and
The method including:
subjecting the battery to charge-discharge cycles, and when a cycling capacity of a battery cell of the battery is less than 80% of an initial capacity of the battery cell, connecting the reference electrode to the negative electrode or the positive electrode to form a current circuit, applying a pulse current to the battery, and respectively compensating the negative electrode or the positive electrode with lithium, or respectively compensating the negative electrode or the positive electrode with sodium to recover the capacity of the battery.

In some embodiments, the pulse current includes a matrix pulse current, the matrix pulse current includes a program of: subjecting the battery to charging at 3 μA for 10 min, and standing for 10 min; subjecting a resulting battery to charging at 3 μA for 10 min, and standing for 10 min; subjecting a resulting battery to charging at 5 μA for 10 min, and standing for 5 min; subjecting a resulting battery to charging at 4 μA for 10 min, and standing for 10 min; and subjecting a resulting battery to charging at 2 μA for 20 min.

Compared with conventional technology, the present disclosure has the following advantages:
I. In the present disclosure, innovative improvements have been made to the design, processing and utilization of reference electrodes for batteries, thereby solving the problems of current reference electrodes of being difficult to apply to batteries, causing damage to battery performance after being implanted, being unable to achieve large-scale application, etc. By means of the coating of a high-load active material, the processing of a planar reference electrode, the preparation of an anti-oxidation coating, integrated electrode sheet implantation and sealing, and other designs, it is ensured that the reference electrode can be prepared and assembled on a large scale in existing production lines and can efficiently and stably monitor the positive electrode potential and negative electrode potential of a battery.
II. By means of the design of a reference electrode sheet, the implantation of the reference electrode in a battery cell, and the design of double-sided coating of an active material, a good ion-transport path between the reference electrode and other electrode sheets in the battery can be ensured, which could improve the reliability of the monitoring of the reference electrode. Moreover, in virtue of a relatively large area and a relatively large active material load, it can be ensured that the reference electrode in service can realize long-term stable monitoring of the positive electrode potential and negative electrode potential of a battery and calculate the state of charge and stage of health of the battery.
III. In the present disclosure, the active material in the reference electrode is innovatively utilized to compensate an aged battery with active lithium/sodium ions to recover the capacity of the battery, thereby realizing battery repair. The secondary capacity recovery and intelligent monitoring functions of a battery are integrated, thereby enabling the multifunctional application of the reference electrode and improving the application value of the reference electrode. In addition, in the present disclosure, a pulse excitation method and an application case for repairing battery capacity damage by means of a reference electrode are also innovatively designed, and the method has universality and can be modified and improved according to actual application scenarios.

### BRIEF DESCRIPTION OF THE DRAWINGS

FIG. 1 is a structural schematic diagram of the reference electrode obtained in example 1;

FIG. 2 is a structural schematic diagram of the cell obtained by assembling a reference electrode in the form of a laminated structure in example 2;

FIG. 3 is a schematic diagram of the operation of the reference electrode in a lithium-ion battery according to an embodiment of the present disclosure;

FIG. 4 is a structural schematic diagram of the reference electrode of an embodiment of the present disclosure in a large-capacity prismatic battery;

FIG. 5 is a schematic diagram of the sealing treatment for the reference electrode of an embodiment of the present disclosure in a large-capacity prismatic battery;

FIG. 6 is a schematic diagram of the sealing treatment for the pouch battery obtained in example 2;

FIG. 7 is a schematic diagram of the positive electrode potential and negative electrode potential of a lithium-ion battery having a graphite negative electrode monitored by the reference electrode prior to sorting in example 2;

FIG. 8A shows information of the positive electrode potential and negative electrode potential of the lithium-ion battery monitored by the reference electrode during long cycles, according to an embodiment of the present disclosure;

FIG. 8B shows a cycling capacity of the lithium-ion battery, according to an embodiment of the present disclosure;

FIG. 9A shows the positive electrode potential and negative electrode potential of the lithium-ion battery monitored by the reference electrode during cycling tests under different rate conditions, according to an embodiment of the present disclosure;

FIG. 9B shows the cycling capacity of the lithium-ion battery, according to an embodiment of the present disclosure;

FIG. 10 is a schematic diagram showing a pulse current applied to a current circuit composed of the reference electrode and the positive/negative electrode of the battery to recover the capacity of battery in example 3; and

FIG. 11 is a schematic diagram showing the recovery of the capacity of battery loss by releasing an active material from the reference electrode in example 3.

### DETAILED DESCRIPTION OF THE EMBODIMENTS

The present disclosure provides a reference electrode, including a current collector, an active layer, and an anti-oxidation layer, the active layer and the anti-oxidation layer being sequentially coated on a surface of the current collector,
where a material of the active layer comprises one selected from the group consisting of a lithium-ion battery active material and a sodium-ion battery active material; and a content of the material of the active layer in the reference electrode is in a range of 0.05-0.08 g/cm²; and
a material of the anti-oxidation layer comprises a solid-state electrolyte.

In the present disclosure, in some embodiments, a material of the current collector includes one or more selected from the group consisting of copper, aluminum, nickel and gold. In some embodiments, the current collector has a morphology including a flat metal foil or a porous metal foil.

In the present disclosure, in some embodiments, the lithium-ion battery active material includes one or more selected from the group consisting of pure lithium, lithium alloys, lithium iron phosphate and lithium titanate. In some embodiments, the sodium-ion battery active material includes one or more selected from the group consisting of pure sodium and sodium alloys. In the present disclosure, in some embodiments, the active layer has a thickness of not less than 6 μm. In the present disclosure, in some embodiments, the active layer has a porosity of not greater than 5%.

In the present disclosure, in some embodiments, the solid-state electrolyte is selected from the group consisting of a hybrid solid-state electrolyte and an oxide solid-state electrolyte. In some embodiments, the hybrid solid-state electrolyte is obtained by mixing a methacrylate-terminated organic/inorganic hybrid polyurethane precursor (m-PPS) and LiTFSI/NMAc, to obtain a eutectic system; and subjecting the eutectic system to UV-initiated in-situ polymerization. In the present disclosure, in some embodiments, the oxide solid-state electrolyte includes one or more selected from the group consisting of lithium lanthanum zirconium tantalum oxide (LLZTO), lithium lanthanum zirconium oxide (LLZO), and lithium aluminum titanium phosphate (LATP). In the present disclosure, in some embodiments, the anti-oxidation layer has a thickness of 2-3 μm.

In the present disclosure, in some embodiments, one end of the reference electrode further includes a reference electrode tab. In some embodiments, the reference electrode tab is a nickel tab surface-plated with copper.

In the present disclosure, in some embodiments, the reference electrode is prepared by a method including:
pressing a material of the active layer onto both sides of the current collector, and rolling the material of the active layer to obtain the active layer; and
preparing the anti-oxidation layer on surfaces of the active layer.

In the present disclosure, in some embodiments, the pressing is conducted at a temperature of 150° C., and a pressure of 0.5 MPa for 3 s. In the present disclosure, in some embodiments, the pressing is conducted in an inert atmosphere. There is no special limitation on the process of rolling, as long as the active layer with the described thickness and porosity can be obtained.

In the present disclosure, in some embodiments, when the material of the anti-oxidation layer is the hybrid solid-state electrolyte, the anti-oxidation layer is prepared by a method including: mixing a methacrylate-terminated organic/inorganic hybrid polyurethane precursor (m-PPS) and LiTFSI/NMAc, to obtain a eutectic system; and subjecting the eutectic system to UV-initiated in-situ polymerization on surfaces of the active layer (for specific steps, see Y. X. Jiang, Y. D. Song, X. Chen, H. J. Wang, L. J. Deng, G. Yang, In Situ Formed Self-Healable Quasi-solid Hybrid Electrolyte Network Coupled with Eutectic Mix Toward Ultra-long Cycle Life Lithium Metal Batteries, Energy Storage Materials, Energy Storage Materials, 2022, 52, 514-523).

In the present disclosure, in some embodiments, when the material of the anti-oxidation layer is the oxide solid-state electrolyte, the anti-oxidation layer is prepared by a process including: mixing an oxide solid-state electrolyte, an organic solvent, a binder and a lithium salt, to obtain a slurry; scrape-coating the slurry onto surfaces of the active layer; and subjecting a resulting system to solvent evaporation, to obtain the anti-oxidation layer.

In the present disclosure, in some embodiments, the lithium salt includes one or more selected from the group consisting of lithium hexafluorophosphate, lithium tetrafluoroborate, lithium bis(fluorosulfonyl)imide, lithium bis(trifluoromethanesulphonyl)imide, lithium perchlorate, and lithium hexafluoroarsenate. In some embodiments, the binder includes one or more selected from the group consisting of polyethylene oxide, polyacrylonitrile, polyvinylidene fluoride and polyvinylidene chloride. In some embodiments, the organic solvent includes butanedinitrile. In the present disclosure, in some embodiments, a mass ratio of the oxide solid-state electrolyte to the organic solvent, the binder, and the lithium salt is in a range of 45-60:4-24:30-40:0.4-3. There is no special limitation on the process of scrape-coating and solvent evaporation, and any scrape-coating and solvent evaporation processes well known to those skilled in the art may be used.

In the present disclosure, in some embodiments, after the reference electrode is obtained, the reference electrode is subjected to charge-discharge tests and voltage monitoring to ensure an accurate potential of the reference electrode. There is no special limitation on the process of the charge-discharge tests and voltage monitoring, and any charge-discharge test and voltage monitoring processes that are well known to those skilled in the art may be used.

The present disclosure further provides a long-lifespan three-electrode battery, including a cell body, an electrolyte solution, and a battery case,
where the cell body comprises a positive electrode, a negative electrode, a separator, and a reference electrode, the reference electrode being the reference electrode as described in the above technical solution.

In the present disclosure, in some embodiments, the separator includes a substrate and a ceramic particle layer coated on a surface of the substrate. In some embodiments, the substrate includes a monolayer film or a multilayer composite film. In some embodiments, the monolayer film includes a PP monolayer film or a PE monolayer film. In some embodiments, the multilayer composite film is consisting of a PP monolayer film and/or a PE monolayer film. In some embodiments, the ceramic particle layer is made of a material including alumina. In some embodiments, the ceramic particle layer has a thickness of 0.7 μm.

In the present disclosure, in some embodiments, the cell body includes a laminated cell body or a wound cell body. In the present disclosure, in some embodiments, the laminated cell body includes the positive electrode, the reference electrode and the negative electrode that are sequentially stacked, where the separator is disposed between the reference electrode and the positive electrode and between the reference electrode and the negative electrode. In the present disclosure, in some embodiments, the reference electrode in the laminated cell body has a size not smaller than the size of the negative electrode.

In the present disclosure, in some embodiments, the wound cell body includes the positive electrode, the reference electrode and the negative electrode that are sequentially stacked and wound, where the separator is disposed between the reference electrode and the positive electrode and between the reference electrode and the negative electrode. In the present disclosure, in some embodiments, the reference electrode in the wound cell body has a size consistent with the size of the positive electrode or the negative electrode.

In the present disclosure, in some embodiments, one end of the positive electrode further includes a positive electrode tab, where the positive electrode tab is an aluminum tab. In some embodiments, one end of the negative electrode further includes a negative electrode tab, where the negative electrode tab is a nickel tab. In some embodiments, the positive electrode tab and the negative electrode tab are located on the same side of the cell body. In some embodiments, the reference electrode tab is located on the same side or the opposite side of the positive electrode tab.

In the present disclosure, in some embodiments, the long-lifespan three-electrode battery includes a pouch battery or a prismatic battery, where the battery case of the pouch battery is an aluminum plastic film case. There is no special limitation on the type of the battery case of the prismatic battery, and any battery case that is well known to those skilled in the art may be used.

The present disclosure further provides a method for preparing the long-lifespan three-electrode battery of the above technical solution including:
providing the cell body; and
placing the cell body in the battery case, filling the battery case with the electrolyte solution and sealing the battery case, and subjecting a resulting battery system to formation and sorting in sequence, to obtain the long-lifespan three-electrode battery.

In the present disclosure, there is no special limitation on the process for preparing the cell body, any process well known to those skilled in the art may be used.

In the present disclosure, there is no special limitation on the type and the addition amount of an electrolyte solution used during electrolyte solution injection, and the type and the addition amount of the electrolyte solution can be adjusted according to the type of a desired battery. In the present disclosure, there is no special limitation on the process of sealing, and any sealing process that is well known to those skilled in the art may be used.

In the present disclosure, there is no special limitation on the process of formation and sorting, and any process of formation and sorting that are well known to those skilled in the art may be used. In the present disclosure, in some embodiments, the method further includes: during the process of formation, monitoring a voltage signal of the positive electrode to the reference electrode and a voltage signal of the negative electrode to the reference electrode throughout. In the present disclosure, by monitoring the voltage signals during the process of formation, battery performance can be monitored as a basis for sorting.

In a particular embodiment of the disclosure, when the long-lifespan three-electrode battery is a pouch battery, the long-lifespan three-electrode battery is prepared by a method including:
placing the cell body into an aluminum plastic film case, and sealing the cell body at the tab side and at the portion below the tab by using a heat sealer, where an aluminum plastic film seal in the bottom of the pouch battery has a length of not less than 6 mm; subjecting a resulting system to drying and cooling, and injecting the electrolyte solution into the aluminum plastic film case in a negative-pressure environment, where the electrodes should be electrically isolated and protected during the process of drying and injecting; then performing first evacuation and sealing; and subjecting a resulting battery to formation and sorting, and then subjecting a resulting battery to second evacuation and sealing, to obtain the pouch battery.

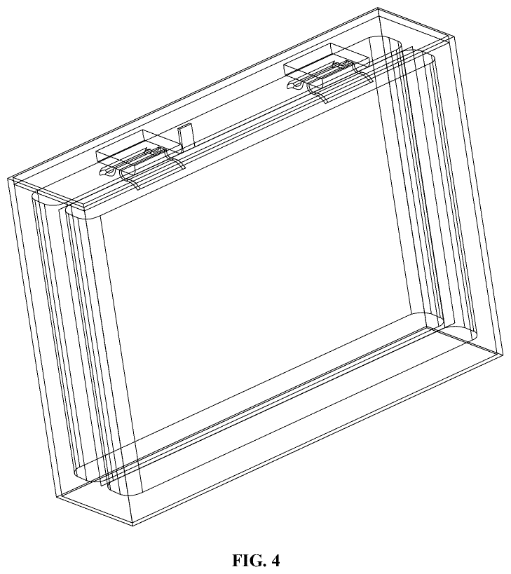

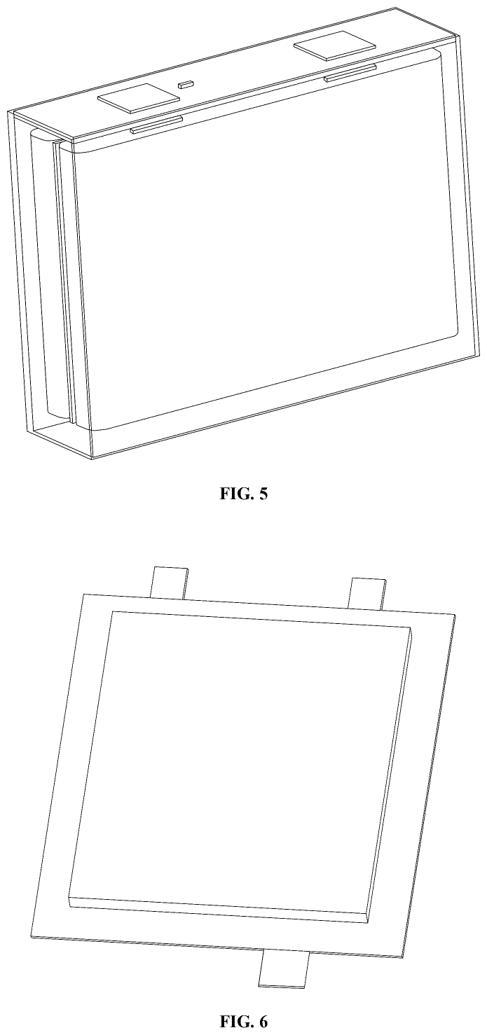

In the present disclosure, when the long-lifespan three-electrode battery is a prismatic battery, FIG. 4 shows a structural schematic diagram of the reference electrode of the present disclosure in a large-capacity prismatic battery; and FIG. 5 shows a schematic diagram of the sealing treatment for the reference electrode of the present disclosure in a large-capacity prismatic battery.

The present disclosure also provides a method for recovering capacity of a battery, the battery being the long-lifespan three-electrode battery as described in the above technical solution or a long-lifespan three-electrode battery prepared by the method as described in the above technical solution,
the method including:
subjecting the battery to charge-discharge cycles, and when a cycling capacity of a battery cell of the battery is less than 80% of an initial capacity of the battery cell, connecting the reference electrode to the negative electrode or the positive electrode to form a current circuit, applying a pulse current to the battery, and respectively compensating the negative electrode or the positive electrode with lithium, or respectively compensating the negative electrode or the positive electrode with sodium to recover the capacity of the battery.

In the present disclosure, in some embodiments, the method further includes: during the process of charge-discharge cycles, monitoring a voltage signal of the positive electrode to the reference electrode and a voltage signal of the negative electrode to the reference electrode throughout. In the present disclosure, by monitoring the voltage signal of the negative electrode to the reference electrode, the state of charge of the battery is determined and charge-discharge management is performed; and the state of health of the battery is determined by means of a differential voltage method. Moreover, the potential fluctuation of the positive/negative electrode of the battery relative to the reference electrode can be used as a reference index for safety management. In the present disclosure, the potential of the positive electrode relative to the reference electrode and the potential of the negative electrode relative to the reference electrode in the battery are first monitored and analyzed; and the state of health of the battery is then evaluated and managed according to the potential of the negative electrode during charging and discharging, the relaxation processes of the positive electrode potential and the negative electrode potential when the battery is left to stand, and the characteristic peaks of curves obtained by calculating and processing increment capacity or differential capacity during charging and discharging of the battery. In the present disclosure, the schematic diagram of the operation of the reference electrode in a lithium-ion battery is shown in FIG. 3.

In the present disclosure, in some embodiments, when the potential of the negative electrode is close to 0 V, charging is immediately stopped.

In the present disclosure, in some embodiments, the cycling capacity of the cell is detected by means of the ampere-hour integration method. In the present disclosure, there is no special limitation on the detection process of the ampere-hour integration method, and any detection process that is well known to those skilled in the art may be used.

In the present disclosure, in some embodiments, the pulse current includes a matrix pulse current. In some embodiments, the matrix pulse current includes a program of: subjecting the battery to charging at 3 μA for 10 min, and standing for 10 min; subjecting a resulting battery to charging at 3 μA for 10 min, and standing for 10 min; subjecting a resulting battery to charging at 5 μA for 10 min, and standing for 5 min; subjecting a resulting battery to charging at 4 μA for 10 min, and standing for 10 min; and subjecting a resulting battery to charging at 2 μA for 20 min.

Unless otherwise specified, the materials and equipment used in the present disclosure are commercially available in the art.

The present disclosure puts forward for the first time a reference electrode sheet, preparation method, processing and use thereof. The present disclosure makes it possible to achieve a large-scale production, stably monitor information of the internal positive electrode potential and negative electrode potential of a battery during long-term service of the battery, prolong the cycle life of the battery, and compensate additional active lithium/sodium to restore the capacity of battery when it is determined that the battery is aged. Therefore, the method makes it possible to provide direct access to the internal information of the battery and improve the cycle performance of the battery, providing a solution for the development and commercial application of new battery management systems and cells.

The technical solutions of the present disclosure will be described clearly and completely below in connection with examples of the present disclosure. Apparently, the described examples are just some examples of the present disclosure, not all of them. Based on the embodiments in the present disclosure, all other embodiments obtained by those skilled in the art without creative effort shall fall within the scope of the present disclosure.

### Example 1

A desired current collector of a reference electrode was a copper sheet current collector obtained by means of laser cutting with a suitable size.

The particles of a lithium-rich alloy (the mass percentage of lithium therein being 95% or higher) were flatly spread on the current collector, an active material was then compacted and bonded to the current collector at a high temperature of 150° C. in an inert gas atmosphere utilizing a press using a pressure of 0.5 MPa, and the pressure was held for 3 s. The above operations were repeated for the back side of the current collector. The current collector was then placed in a roll press for rolling to obtain an active layer, the active layer having a thickness of 6 μm and a porosity of 5%.

A mixed liquid substance of a eutectic system composed of an inorganic hybrid polyurethane precursor (m-PPS) and LiTFSI/NMAc was spin-coated onto two sides of the active layer utilizing a coater and was then cured through UV irradiation (for the specific composition of the eutectic system and curing conditions, see Y. X. Jiang, Y. D. Song, X. Chen, H. J. Wang, L. J. Deng, G. Yang, In Situ Formed Self-Healable Quasi-solid Hybrid Electrolyte Network Coupled with Eutectic Mix Toward Ultra-long Cycle Life Lithium Metal Batteries, Energy Storage Materials, 2022, 52, 514-523), to obtain an anti-oxidation layer having a thickness of 2 μm, such that the reference electrode could be obtained, where the content of the lithium-rich alloy on the reference electrode was 0.07 g/cm².

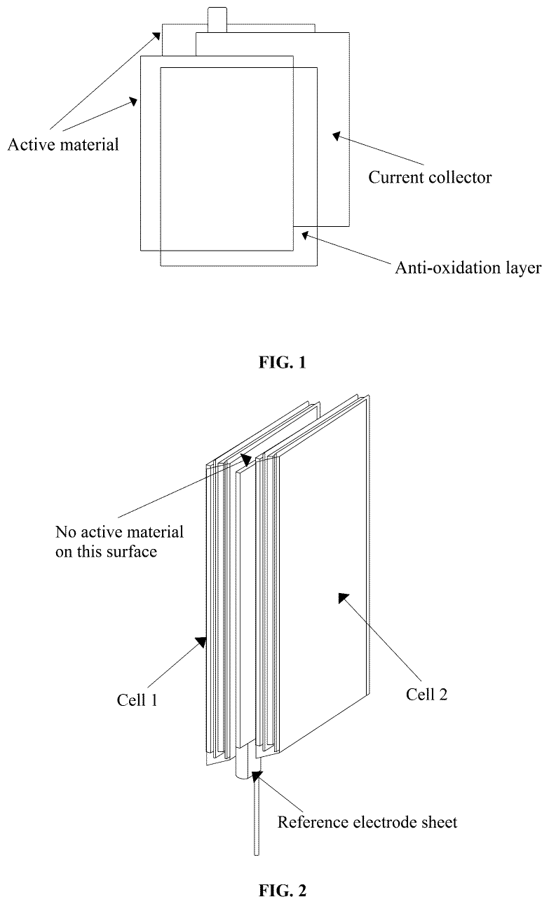

FIG. 1 shows a structural schematic diagram of the obtained reference electrode.

### Example 2

A three-electrode battery was prepared by using the reference electrode obtained in example 1.

In the present example, the three-electrode battery was a laminated pouch battery. A battery with a capacity of 1.2 Ah was prepared from a combination of an NCM523 positive electrode and a graphite negative electrode through a lamination process.

The capacity of a battery was determined according to requirements, then, the number of positive electrode sheets and negative electrode sheets and the areal capacity of the electrode sheets were determined. Taking a capacity of battery of 1.2 Ah as an example, the number of positive electrode sheets was 11, and the number of negative electrode sheets was 12. The two-dimensional dimension of the reference electrode was determined to be 45×58 mm according to the size of a cell in the pouch battery and subsequent battery management requirements. The areal capacity of the reference electrode, the assembly process, and the stacking sequence were determined through a rational design of the functional requirements for the internal reference electrode of the battery in combination with a preparation process for the battery.

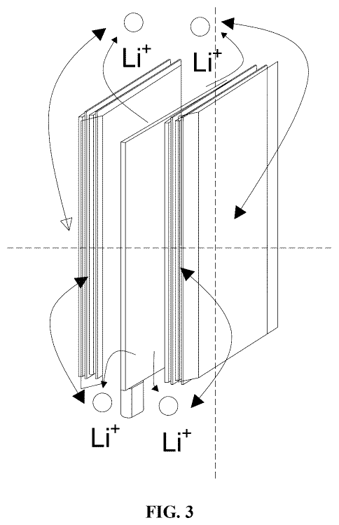

A zigzag lamination process (i.e. the reference electrode tab being located on the opposite side of a positive electrode tab) was utilized, and the reference electrode was stacked and assembled with other electrode sheets. It was worthy of special attention that two electrode sheets adjacent to the reference electrode were subjected to single-side coating, and the two electrode sheets were simultaneously as positive electrode sheets or negative electrode sheets, whereas electrode sheets at other locations were assembled in such a way that positive electrode sheets and negative electrode sheets were alternately stacked. The cell was fixed through a fixing adhesive tape upon the completion of stacking, and the assembled cell is shown in FIG. 2.

A tab lead of the reference electrode was led out from below the cell and was welded with a nickel tab that was surface-plated with copper. The aluminum tab and the nickel tab were respectively welded onto the positive and negative electrodes, thereby obtaining a laminated cell body.

The cell body was then placed in an aluminum plastic film case, and the cell was sealed at the tab side and at the portion below the tab by means of a heat sealer. The reference electrode tab was also sealed and then connected to an external device, and in order to ensure the sealing performance of the battery, an aluminum plastic film seal in the bottom of the pouch battery has a length of not less than 6 mm.

Drying a resulting battery system in a high-temperature vacuum oven and cooling the same. Then, an electrolyte solution (1 M LiPF6 in a mixed solvent of EC:DMC:DEC, a volume ratio of EC:DMC:DEC being 1:1:1) matching with the capacity of the cell was injected into a pouch battery packaging bag in a negative-pressure environment. The reference electrode and the positive and negative electrodes should be electrically isolated and protected during drying and electrolyte solution injection.

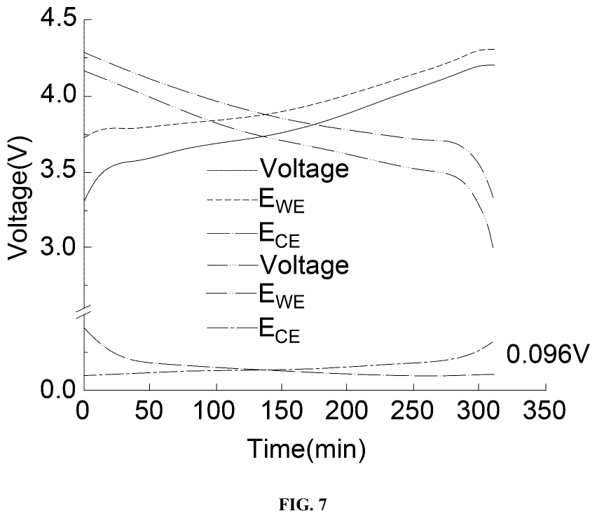

A resulting battery was subjected to first evacuation and sealing, then to formation and sorting, and then a resulting battery was subjected to second evacuation and sealing, to obtain the three-electrode battery. FIG. 6 shows a schematic diagram of a sealing treatment for the pouch battery obtained in example 2. Throughout the whole process of formation, voltage signals were monitored, including the voltage signal of the positive electrode to the reference electrode and the voltage signal of the negative electrode to the reference electrode, where potential information obtained before sorting is shown in FIG. 7.

### Example 3

The three-electrode battery obtained in Example 2 was subjected to battery management and capacity recovery.

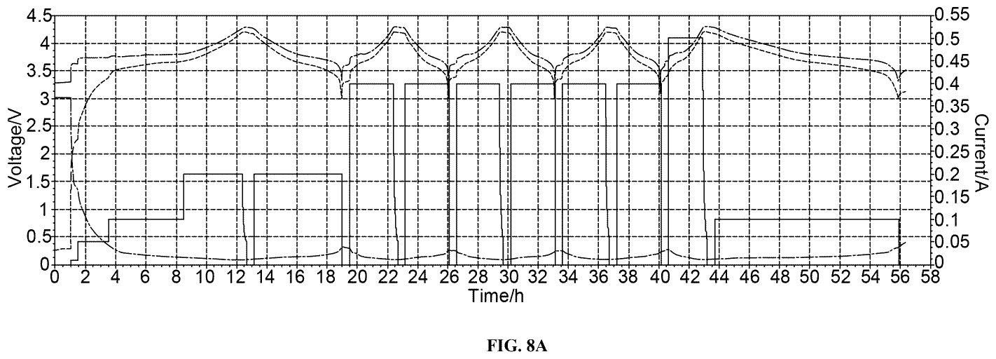

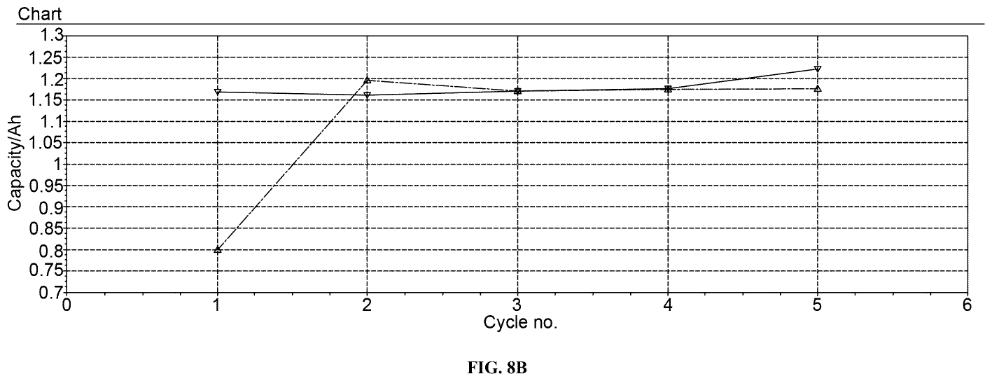

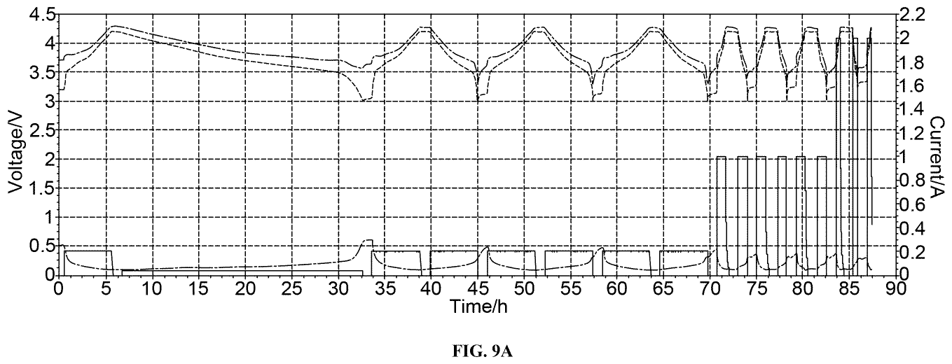

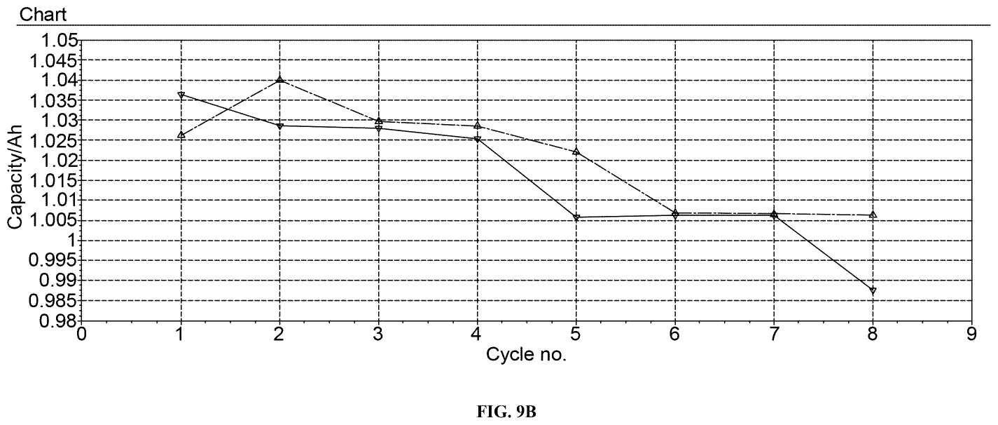

The three-electrode battery obtained in Example 2 was subjected to charge-discharge cycles, and voltage signals throughout the whole process of the charge-discharge cycles were monitored, including the voltage signal of the positive electrode to the reference electrode and the voltage signal of the negative electrode to the reference electrode. FIG. 8A to FIG. 8B shows a schematic diagram of the positive electrode potential and negative electrode potential of a lithium-ion battery monitored by the reference electrode during long cycles, where FIG. 8A shows information of the positive electrode potential and negative electrode potential, and the FIG. 8B shows a cycling capacity of the battery. FIG. 9A to FIG. 9B shows a schematic diagram of the positive electrode potential and negative electrode potential of the lithium-ion battery monitored by the reference electrode during cycling tests under different rate conditions, where FIG. 9A shows the positive electrode potential and negative electrode potential at different rates, and FIG. 9B shows the cycling capacity of the battery.

By monitoring the voltage signal of the negative electrode to the reference electrode, the state of charge of the battery was determined and charge-discharge management was performed; and the state of health of the battery was determined through a differential voltage method. Moreover, the potential fluctuation of the positive/negative electrode of the battery to the reference electrode could be used as a reference index for safety management. When the potential of the graphite negative electrode was close to 0 V, charging should be stopped immediately.

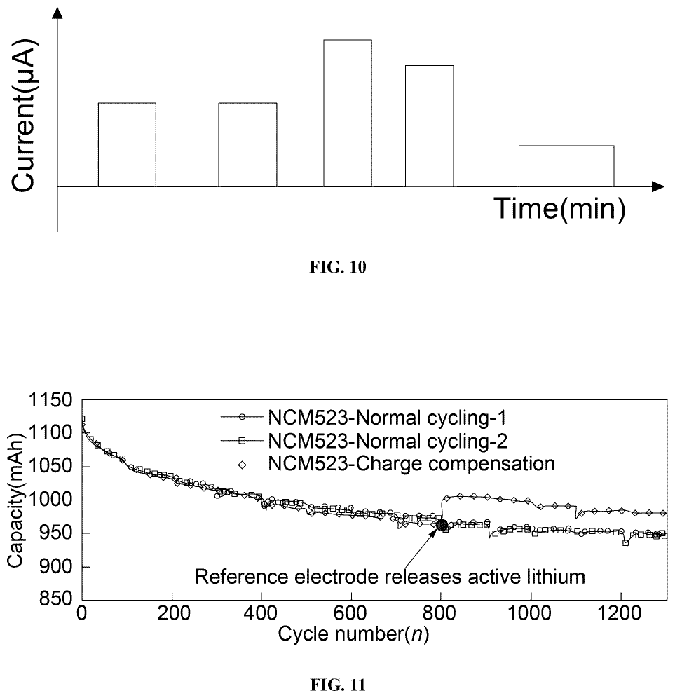

The cycling capacity of the battery was detected through the ampere-hour integration method. When the cycling capacity of the cell of the battery was less than 80% of the initial capacity thereof, the reference electrode and the negative electrode were made to form a current circuit, and active lithium ions in the reference electrode were released and transported to the negative electrode by applying external excitation, to compensate for reduction in the capacity of battery due to the loss of active lithium during battery cycling and aging and the growth of an SEI film on the negative electrode. In the present embodiment, a matrix pulse current excitation solution was utilized, and an excitation current was controlled at a micro-ampere level. The specific steps of the matrix pulse current excitation solution are shown in FIG. 10. After the negative electrode was compensated with lithium, the reference electrode and the positive electrode were made to form a circuit, and the above steps were repeated to compensate the positive electrode with lithium. By designing the external circuits and excitation steps, active lithium/sodium ions were released into an electrolyte solution and positive and negative active materials, and participated in the charge-discharge cycles of the battery, thereby achieving capacity recovery of the battery.

After the current excitation, the battery having undergone the capacity recovery operation was subjected to electrochemical testing, and the capacity and impedance characteristics of the battery were recalibrated. The battery was put into service again after testing and sorting, and the state of charge, the state of health and the safety state of the battery during the cyclic application thereof were monitored. As shown in FIG. 11, the pouch battery in the present embodiment is decayed to 80% after 800 cycles at 1C. At this moment, the cycling testing was stopped, active lithium was released from the reference electrode to compensate the battery with lithium. After the battery was compensated with active lithium from the reference electrode, the battery is recovered to a capacity of 55 mAh, and the battery runs steadily in subsequent 400 cycles without significant loss of capacity of battery.

In summary, the solution of the present disclosure has been successfully applied to rechargeable batteries, a cell internally implanted with a reference electrode is processed by using a conventional solution, and the positive electrode potential and negative electrode potential of a battery are also stably detected during the formation and long cycles of the battery. When the capacity of the battery decays, an external circuit is utilized to stimulate the reference electrode to release active lithium, thereby effectively compensating for active lithium loss of the battery during cycling and recovering capacity of battery. After capacity repair, the battery continuously and stably run 400 cycles without significant capacity loss.

In the present disclosure, the process of implanting a reference electrode into a battery is effectively simplified, the implantation cost thereof is effectively reduced, and the multiple functions of potential monitoring and capacity repair are integrated in the reference electrode. In practical application, the reference electrode proposed in the present disclosure accurately monitors the positive electrode potential and negative electrode potential of a battery during operation, and greatly reduces the use cost of the reference electrode. Therefore, the technical solution proposed in the present electrode potential can be applied to lithium-ion batteries and sodium-ion batteries, and can be applied to both pouch batteries and prismatic batteries. The designed capacity recovery method can effectively improve the cycle life and economical efficiency of batteries. The above solution ensures a large-scale preparation of a reference electrode, achieves stable monitoring of positive electrode potential and negative electrode potential during battery operation, and can recover the capacity of battery when a battery is aged.

Although the examples described above provides a detailed description of the present disclosure, they are only a part of, rather than all of the examples of the present disclosure. All other examples that can be obtained according to the examples of the present disclosure without creative efforts shall fall within the scope of the present disclosure.

What is claimed is:

1. A reference electrode, comprising a current collector, an active layer, and an anti-oxidation layer, the active layer and the anti-oxidation layer being sequentially coated on a surface of the current collector, wherein
a material of the active layer comprises one selected from the group consisting of a lithium-ion battery active material and a sodium-ion battery active material; and a content of the material of the active layer in the reference electrode is in a range of 0.05-0.08 g/cm²; and
a material of the anti-oxidation layer comprises a solid-state electrolyte.

2. The reference electrode of claim 1, wherein the active layer has a thickness of not less than 6 μm; and the anti-oxidation layer has a thickness of 2-3 μm.

3. The reference electrode of claim 1, wherein one end of the reference electrode further comprises a reference electrode tab, the reference electrode tab being a nickel tab surface-plated with copper.

4. A long-lifespan three-electrode battery, comprising a cell body, an electrolyte solution, and a battery case,
wherein the cell body comprises a positive electrode, a negative electrode, a separator, and a reference electrode, the reference electrode being the reference electrode of claim 1.

5. The long-lifespan three-electrode battery of claim 4, wherein the cell body comprises one selected from the group consisting of a laminated cell body and a wound cell body;
the laminated cell body comprises the positive electrode, the reference electrode and the negative electrode that are sequentially stacked, the separator being disposed between the reference electrode and the positive electrode and between the reference electrode and the negative electrode; and
the wound cell body comprises the positive electrode, the reference electrode and the negative electrode that are sequentially stacked and wound, the separator being disposed between the reference electrode and the positive electrode and between the reference electrode and the negative electrode.

6. The long-lifespan three-electrode battery of claim 4, wherein one end of the positive electrode further comprises a positive electrode tab, the positive electrode tab being an aluminum tab;
one end of the negative electrode further comprises a negative electrode tab, the negative electrode tab being a nickel tab;
the positive electrode tab and the negative electrode tab are located on a same side of the cell body; and
the reference electrode tab is located on a same side or an opposite side of the positive electrode tab.

7. The long-lifespan three-electrode battery of claim 4, wherein the long-lifespan three-electrode battery comprises one selected from the group consisting of a pouch battery and a prismatic battery, and the battery case of the pouch battery is an aluminum plastic film case.

8. The long-lifespan three-electrode battery of claim 4, wherein the active layer has a thickness of not less than 6 μm; and the anti-oxidation layer has a thickness of 2-3 μm.

9. The long-lifespan three-electrode battery of claim 4, wherein one end of the reference electrode further comprises a reference electrode tab, the reference electrode tab being a nickel tab surface-plated with copper.

10. A method for preparing the long-lifespan three-electrode battery of claim 4, comprising:
providing the cell body; and
placing the cell body in the battery case, filling the battery case with the electrolyte solution and sealing the battery case, and subjecting a resulting battery system to formation and sorting in sequence, to obtain the long-lifespan three-electrode battery.

11. The method of claim 10, wherein the cell body comprises one selected from the group consisting of a laminated cell body and a wound cell body;
the laminated cell body comprises the positive electrode, the reference electrode and the negative electrode that are sequentially stacked, the separator being disposed between the reference electrode and the positive electrode and between the reference electrode and the negative electrode; and
the wound cell body comprises the positive electrode, the reference electrode and the negative electrode that are sequentially stacked and wound, the separator being disposed between the reference electrode and the positive electrode and between the reference electrode and the negative electrode.

12. The method of claim 10, wherein one end of the positive electrode further comprises a positive electrode tab, the positive electrode tab being an aluminum tab;
one end of the negative electrode further comprises a negative electrode tab, the negative electrode tab being a nickel tab;
the positive electrode tab and the negative electrode tab are located on a same side of the cell body; and
the reference electrode tab is located on a same side or an opposite side of the positive electrode tab.

13. The method of claim 10, wherein the long-lifespan three-electrode battery comprises one selected from the group consisting of a pouch battery and a prismatic battery, and the battery case of the pouch battery is an aluminum plastic film case.

14. A method for recovering capacity of a battery, the battery being the long-lifespan three-electrode battery of claim 4, and
the method comprising:
subjecting the battery to charge-discharge cycles, and when a cycling capacity of a battery cell is less than 80% of an initial capacity of the battery cell, connecting the reference electrode to the negative electrode or the positive electrode to form a current circuit,
applying a pulse current to the battery, and
respectively compensating the negative electrode or the positive electrode with lithium, or respectively compensating the negative electrode or the positive electrode with sodium to recover the capacity of the battery.

15. The method of claim 14, wherein the pulse current comprises a matrix pulse current, and the matrix pulse current comprises a program of:
subjecting the battery to charging at 3 μA for 10 min, and standing for 10 min;
subjecting a resulting battery to charging at 3 μA for 10 min, and standing for 10 min;
subjecting a resulting battery to charging at 5 μA for 10 min, and standing for 5 min;
subjecting a resulting battery to charging at 4 μA for 10 min, and standing for 10 min; and
subjecting a resulting battery to charging at 2 μA for 20 min.

16. The method of claim 14, wherein the active layer has a thickness of not less than 6 μm; and the anti-oxidation layer has a thickness of 2-3 μm.

17. The method of claim 14, wherein one end of the reference electrode further comprises a reference electrode tab, the reference electrode tab being a nickel tab surface-plated with copper.

18. The method of claim 14, wherein the cell body comprises one selected from the group consisting of a laminated cell body and a wound cell body;
the laminated cell body comprises the positive electrode, the reference electrode and the negative electrode that are sequentially stacked, the separator being disposed between the reference electrode and the positive electrode and between the reference electrode and the negative electrode; and
the wound cell body comprises the positive electrode, the reference electrode and the negative electrode that are sequentially stacked and wound, the separator being disposed between the reference electrode and the positive electrode and between the reference electrode and the negative electrode.

19. The method of claim 14, wherein one end of the positive electrode further comprises a positive electrode tab, the positive electrode tab being an aluminum tab;
one end of the negative electrode further comprises a negative electrode tab, the negative electrode tab being a nickel tab;
the positive electrode tab and the negative electrode tab are located on a same side of the cell body; and
the reference electrode tab is located on a same side or an opposite side of the positive electrode tab.

20. The method of claim 14, wherein the long-lifespan three-electrode battery comprises one selected from the group consisting of a pouch battery and a prismatic battery, and the battery case of the pouch battery is an aluminum plastic film case.
